(19) United States
(12) Patent Application Publication
(10) Pub. No.: US 2019/0034372 A1
(43) Pub. Date: Jan. 31, 2019

(54) MULTIPLE DEVICE PERIPHERAL COMPONENT INTERCONNECT EXPRESS (PCIe) CARD

(71) Applicant: Intel Corporation, Santa Clara, CA (US)

(72) Inventors: Dirk Blevins, Russell Springs, KY (US); Kevin Devey, Limerick (IE); Todd Cameron Langley, Chandler, AZ (US)

(21) Appl. No.: 15/843,201

(22) Filed: Dec. 15, 2017

(51) Int. Cl. G06F 13/40; G06F 13/16; G06F 13/42

(52) U.S. Cl. CPC G06F 13/4068; G06F 2213/0026; G06F 13/4291; G06F 13/1673

(57) ABSTRACT

Techniques are provided for multiple device Peripheral Component Interface Express (PCIe) card having a single slot connector and each device interfaces with the single slot connector using distinct, unshared, data lane terminals of the single slot connector. In an example, a PCIe card can include a first device mounted to a circuit board and a second device mounted to the circuit board. The first device can be connected to a first plurality of data lane terminals of a single slot connector of the circuit board. The second device can be connected to a second plurality of data lane terminals of the single slot connector. The first plurality of data lane terminals can be distinct from the second plurality of data lane terminals.

### TECHNICAL FIELD

This document pertains generally, but not by way of limitation, to expansion cards for computer motherboards, and more particularly to providing multiple devices using a single expansion slot of the motherboard.

### BACKGROUND

Conventional server system architectures can limit the amount of network connectivity when the choice of server form factor physically limits the space available for expansion cards. For example, the 1U height form factor generally provides only 2 peripheral component interconnect express (PCIe) slots. In order to meet the performance for server growth, more network connectivity is needed from standard 1U high server products.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally an example PCIe interface card hosting multiple devices without a switch.

FIG. 2 illustrates generally an example single slot PCIe card including multiple network interface controllers.

FIG. 3 illustrates generally an example single slot PCIe card including multiple network interface controllers.

FIG. 4 illustrates generally a flowchart of an example method for operating a PCIe interface card having multiple interface devices and a single PCIe slot connector.

FIG. 5 illustrates a block diagram of an example machine upon which any one or more of the techniques (e.g., methodologies) discussed herein may perform.

FIG. 6 illustrates a system level diagram, depicting an example of an electronic device (e.g., system) that can include a multiple-device, single-connector, PCIe interface card as described in the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Conventional attempts at providing increased network connectivity using standard IRU expansion cards use a network switch. Although connectivity can be increased, the use of a switch on the expansion cards introduces thermal costs and performance loss such that the addition of, for example, an additional network interface controller (NIC) does not result in a doubling of networking capacity. In addition, software drivers to interface the switch-based expansion cards are specific to each card and may not be available across multiple operating systems.

The present inventors have recognized a solution that allows a single expansion slot to provide multiple devices to a host system. In certain examples, the solution does not impact the bandwidth of each device nor does the solution complicate provisioning of resources. In certain examples, from a software perspective, no modifications are required. In certain examples, the solution can increase I/O capability to high volume servers without any modification to the server itself compared to conventional methods.

In an example, in the space of one PCIe expansion card, two independent devices can be presented to the system. For example, a single Ethernet interface card, according to the present subject matter, can provide double the networking connectivity and bandwidth a conventional expansion card can provide to a high volume server. Such increased connectivity can expand the capabilities and MSS which a server can address.

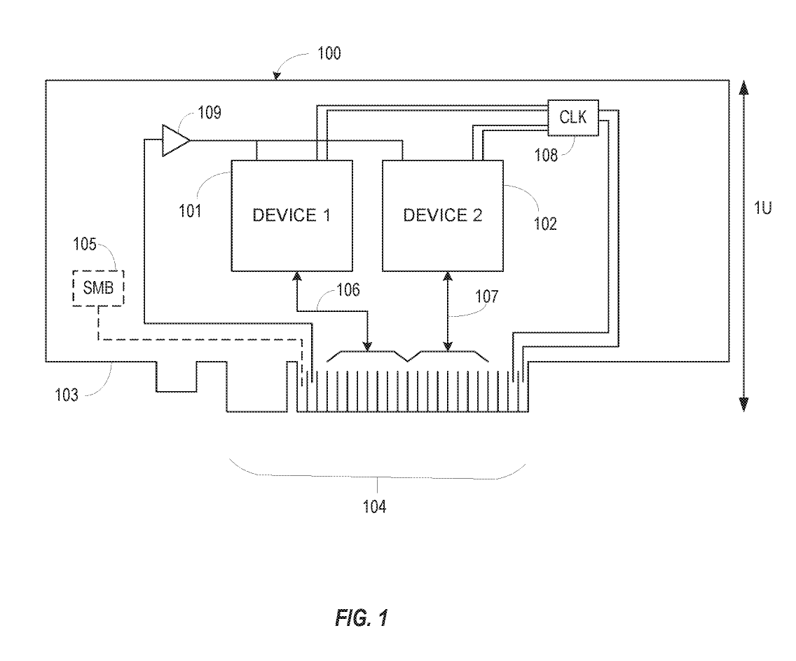

FIG. 1 illustrates generally an example PCIe interface card 100 hosting multiple devices 101, 102 without a switch to share data lanes of the PCIe bus with the multiple devices 101, 102. The PCIe interface card 100 can include a PCIe circuit board 103, a PCIe connector 104, a first device 101, and a second device 102. In certain examples, the printed circuit board 103 can be in the form of a single rack unit (1U), or about 44.50 millimeters (1.752 inches) or less in height. In certain examples, the PCIe interface card 100 can optionally include a circuit 105 coupled to a communication bus such as a system management bus (SMBus). A PCIe bus and connector can be divided into a number of data lanes. Each data lane can include two pairs of conductors, one for receiving and one for transmitting. A PCIe card can have one (x1), four (x4), eight (x8), or sixteen (x16) data lanes associated with a single PCIe slot. In certain examples, the present subject matter associates one or more data lanes, or data lane terminations, with one of the plurality of devices 101, 102 on the PCIe circuit board 100. In the example of FIG. 1, the PCIe card 100 can be an “x16” card. The first device 101 can be connected to data lanes 0-7 (106) and the second device 102 can be connected to data lanes 8-16 (107). Compared to conventional devices, the PCIe card of FIG. 1 does not include a switch or divider circuit to multiplex the data lanes of each device 101, 102 with the connector 104. Instead, the data lanes 106, 107 of each device 101, 102 are couple directly to the terminals of the slot connector 104. With each device 101, 102 connected directly to terminals of the slot connector 104, each device 101, 102 can be recognized by the host system, and the host system resources, as an individual device or port. Thus, standard software mechanisms of each device 101, 102 can be utilized without change or impact to the full capability of the device 101, 102.

In certain examples, the basic input and output system (BIOS) of the host system can be adjusted to allow multiple devices to be recognized in a single PCIe slot using directly connected data lanes. Although the BIOS can be adjusted manually, in certain examples, the PCIe interface card 100 can include a circuit 105 that adjust the BIOS and allows the host system to recognize multiple devices or ports using a single PCIe slot. In some examples, the circuit 105 can be coupled to and can communicate using a system management bus (SMBus) of the host system via the connector 104.

In certain examples, support signals of the PCIe bus, such as can be split between the multiple devices using, for example, but not by way of limitation, buffers, such as a clock buffer (CLK) 108 or logic circuits 109. Such support signals can include, but are not limited to, reset signals, one or more clock signals, a wake signal, Joint Test Access Group (JTAG) signals, a clock request signal, a presence signal or combination thereof. It is understood that although the example of FIG. 1 shows two devices, more devices are possible without departing from the scope of the present subject matter. For example, but not by way of imitation, an x16 PCIe card can include up to 16 devices such that each device is allocated a data lane and each data lane is recognized by the host system as an individual device. IN certain examples, the devices can include storage devices such as non-volatile memory (NVMe) devices, device interfaces for displays, communication or networking devices, or combinations thereof.

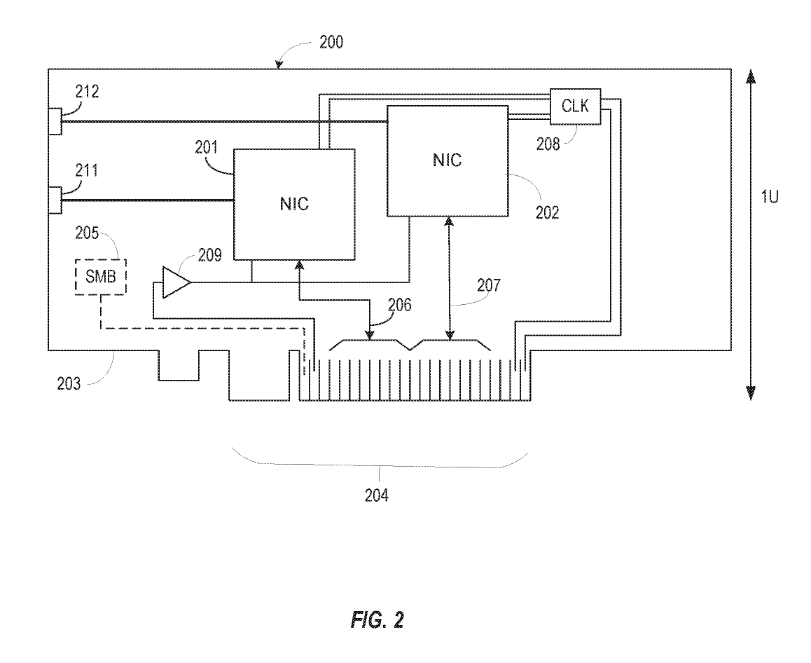

FIG. 2 illustrates generally an example single slot PCIe network interface card 200 including multiple network interface controllers 201, 202. The PCIe network interface card 200 can include a printed circuit board 203, a first network interface controller 201, a second network interface controller 202, first and second network connectors 211, 212, and slot connector terminals 204. In certain examples, the printed circuit board 203 can be in the form of a single rack unit (1U), or about 44.50 millimeters (1.752 inches) or less in height. The printed circuit board 203 supports the mounting and interconnection of the network controllers 201, 202, network connectors 211, 212 and the slot terminations of the slot connector 204. In certain examples, the first network interface controller 201 can be directly connected with a first set of data lanes 206 of the PCIe bus via the a first set of slot connector terminals, and the second network interface controller 202 can be directly connected with a second set of data lanes 207 of the PCIe bus via the a second set of slot connector terminals. The first set of data lanes 206 can be distinct from, or not-overlapping, the second set of data lanes 207, and the first set of slot connector terminals can be distinct from the second set of slot connector terminals. For example, for 2x PCIe card, the first network interface controller 201 can connect to data lane 0 and the second network interface controller 202 can connect to data lane 1. For a 16x PCIe card, the first network interface controller 201 can connect to data lanes 0-7 and the second network interface controller 202 can connect to data lane 8-15. In certain examples, each network interface controller 201, 202 can independently support a single high speed Ethernet connection, such as a 100 gigabyte per second Ethernet connection.

In certain examples, the PCIe network interface card 200 can optionally include a circuit 205 coupled to a communication bus such as a system management bus (SMBus). In certain examples, the basic input and output system (BIOS) of the host system can be adjusted to allow multiple devices to be recognized in a single PCIe slot using directly connected data lanes. Although the BIOS can be adjusted manually, in certain examples, the PCIe network interface card 200 can include a circuit 205 that adjust the BIOS and allows the host system to recognize multiple devices or ports using a single PCIe slot. In some examples, the circuit 205 can be coupled to and can communicate using a system management bus (SMBus) of the host system via the connector 204.

In certain examples, support signals of the PCIe bus, such as can be split between the multiple devices using, for example, but not by way of limitation, buffers 208 or logic circuits 209. Such support signal can include, but are not limited to, reset signals, one or more clock signals, a wake signal, JTAG signals, a clock request signal, a presence signal or combination thereof.

The illustrated example of FIG. 2 deviates from conventional cards with dual network controllers by only having a 1U height and not including a switch or divider mechanism to share data lane connections of the two controllers with the slot connector terminals of the single slot. Each network interface controller 201, 202 can be recognized as an individual device and can operate independently from the other. The direct data lane connections 206, 207 can achieve performance and throughput extremes that are otherwise limited by shared data lane connections using a switch or dividing mechanism.

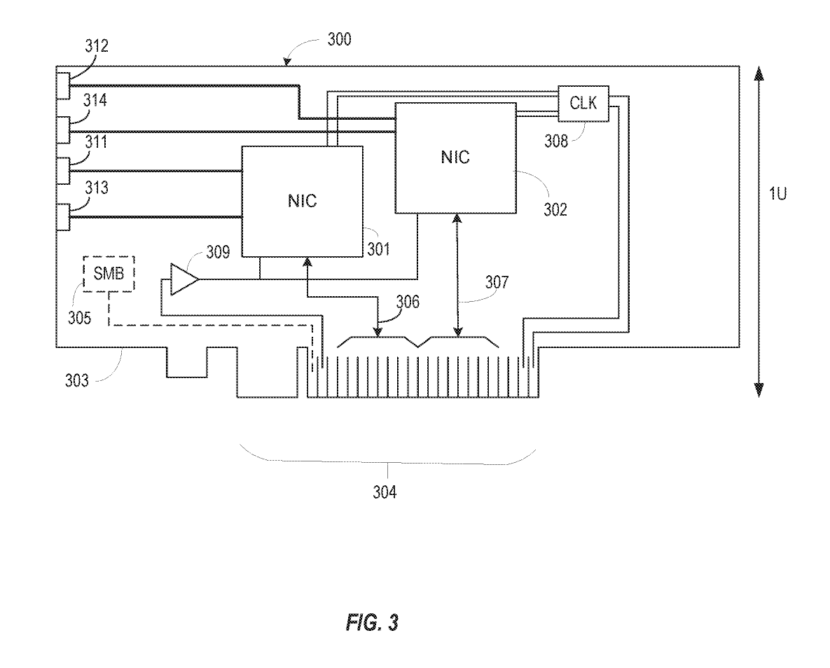

FIG. 3 illustrates generally an example single slot PCIe network interface card 300 including multiple network interface controllers 301, 302. The PCIe network interface card 300 can include a printed circuit board 303, a first network interface controller 301, a second network interface controller 302, four network connectors 311, 312, 313, 314, and a single slot connector 304 and associated terminals. In certain examples, the printed circuit board 303 can be in the form of a single rack unit (1U), or about 44.50 millimeters (1.752 inches) or less in height. The printed circuit board 303 supports the mounting and interconnection of the network controllers 301, 302, network connectors 311, 312, 313, 314 and the slot terminations. In certain examples, the first network interface controller 301 can be directly connected with a first set of data lanes 306 of the PCIe bus via the a first set of slot connector terminals, and the second network interface controller 302 can be directly connected with a second set of data lanes 307 of the PCIe bus via the a second set of slot connector terminals. The first set of data lanes 306 can be distinct from, or not-overlapping, the second set of data lanes 307, and the first set of slot connector terminals can be distinct from the second set of slot connector terminals. For example, for 2x PCIe card, the first network interface controller 301 can connect to data lane 0 and the second network interface controller 302 can connect to data lane 1. For a 16x PCIe card, the first network interface controller 301 can connect to data lanes 0-7 and the second network interface controller 302 can connect to data lane 8-15. In certain examples, each network interface controller 301, 302 can independently support two high speed Ethernet connections, such as a 25 gigabyte per second Ethernet connections.

In certain examples, the PCIe network interface card 300 can optionally include a circuit 305 coupled to a communication bus such as a system management bus (SMBus). In certain examples, the basic input and output system (BIOS) of the host system can be adjusted to allow multiple devices to be recognized in a single PCIe slot using directly connected data lanes. Although the BIOS can be adjusted manually, in certain examples, the PCIe network interface card 300 can include a circuit 305 that adjust the BIOS and allows the host system to recognize multiple devices or ports using a single slot PCIe slot. In some examples, the circuit 305 can be coupled to and can communicate using a system management bus (SMBus) of the host system via the connector 304.

In certain examples, support signals of the PCIe bus, such as can be split between the multiple devices using, for example, but not by way of limitation, buffers 308 or logic circuits 309. Such support signals can include, but are not limited to, reset signals, one or more clock signals, a wake signal, JTAG signals, a clock request signal, a presence signal or combination thereof.

The illustrated example of FIG. 3 deviates from conventional cards with dual network controllers by only having a 1U height and not including a switch or divider mechanism to share data lane connections of the two controllers with the slot connector terminals of the single slot. Each network interface controller 301, 302 can be recognized as an individual device and can operate independently from the other. The direct data lane connections 306, 307 can achieve performance and throughput extremes that are otherwise limited by a shared data lane connections using a switch or dividing mechanism.

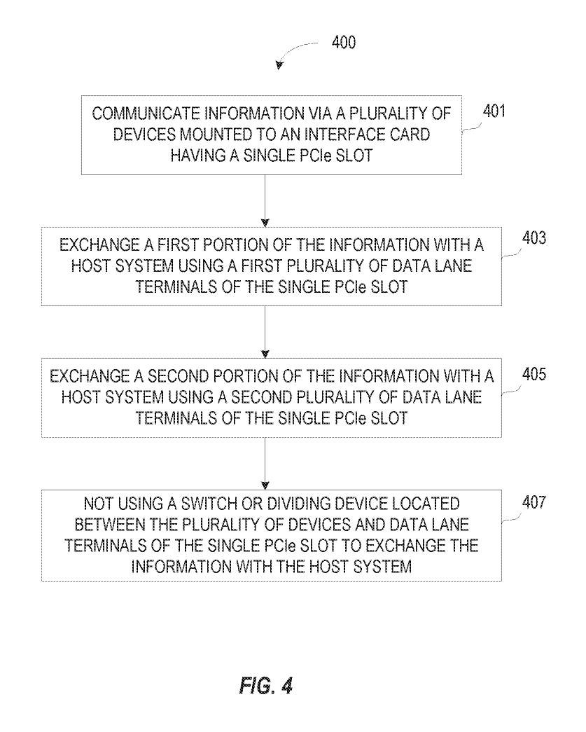

FIG. 4 illustrates generally a flowchart of an example method for operating a PCIe interface card having multiple interface devices and a single PCIe slot connector. In certain examples, the PCIe interface card has a 1U form factor. At 401, the card communicates information, for example, using two or more Ethernet connections of two or more devices mounted to a printed circuit board of the PCIe interface card. At 403, a first portion of the information is exchanged with a host system using a first portion of the PCIe data lanes available via the single PCIe slot connector. At 405, a first portion of the information is exchanged with a host system using a second portion of the PCIe data lanes available via the single PCIe slot connector. In certain examples, the first portion of PCIe data lanes is separate from and does not overlap the second portion of PCIe data lanes. At 407, the exchange of information with the host system does not employ a switch or divider device between the communication devices mounted on the PCIe interface card and the data lane terminals of the single PCIe slot connector.

The examples discussed above can allow servers to provide more functionality without increasing rack space. In some examples, a server can nearly double network connectivity of 1U rack using the examples discussed above. In certain examples, the physical domain and the electrical domain of data lane signals of one PCIe device of a PCIe interface card can be separate from the physical domain and the electrical domain of other PCIe devices of the PCIe interface card thus allowing each PCIe device to be recognized as an individual device and to allow independent operation of each PCIe device using all design mechanisms such that performance of each PCIe device is not impeded compared to devices that are required to share data lanes of a PCIe bus or connector.

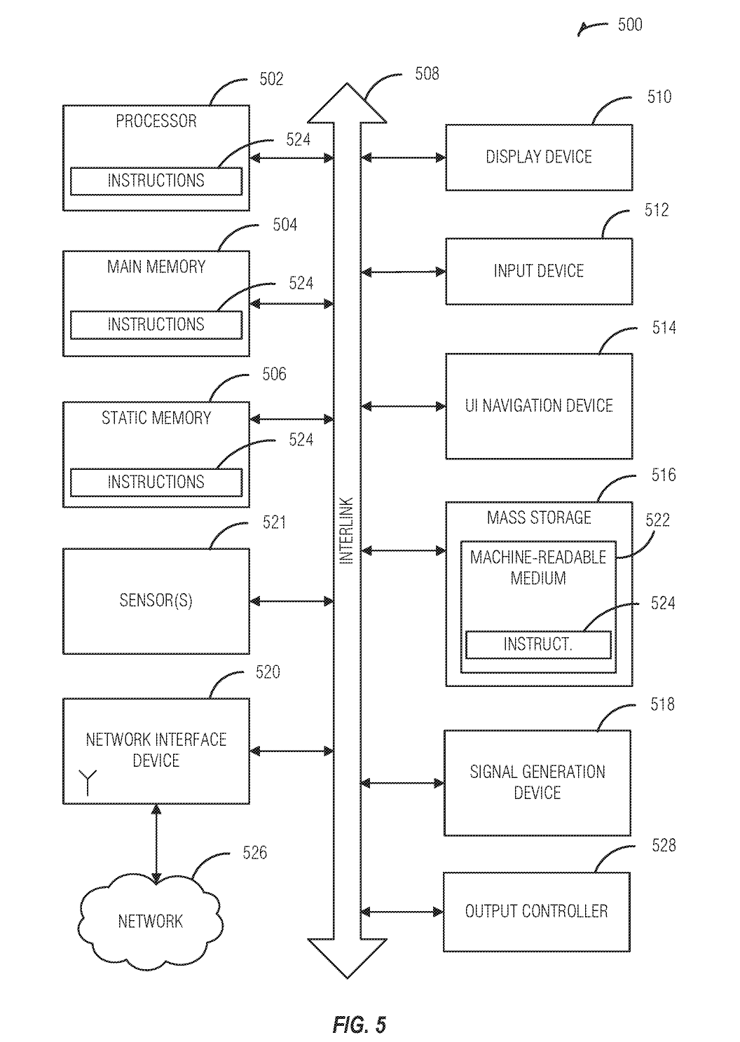

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (or other distributed) network environment. As used herein, peer-to-peer refers to a data link directly between two devices (e.g., it is not a hub-and spoke topology). Accordingly, peer-to-peer networking is networking to a set of machines using peer-to-peer data links. The machine 500 may be a single-board computer, an integrated circuit package, a system-on-a-chip (SOC), a personal computer (PC), a tablet PC, a set-top box (STB), a personal digital assistant (PDA), a mobile telephone, a web appliance, a network router, or other machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In certain examples, any one or more of the display unit 510, storage device 516, network interface device or combination thereof can include a multiple device PCIe card as discussed above.

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

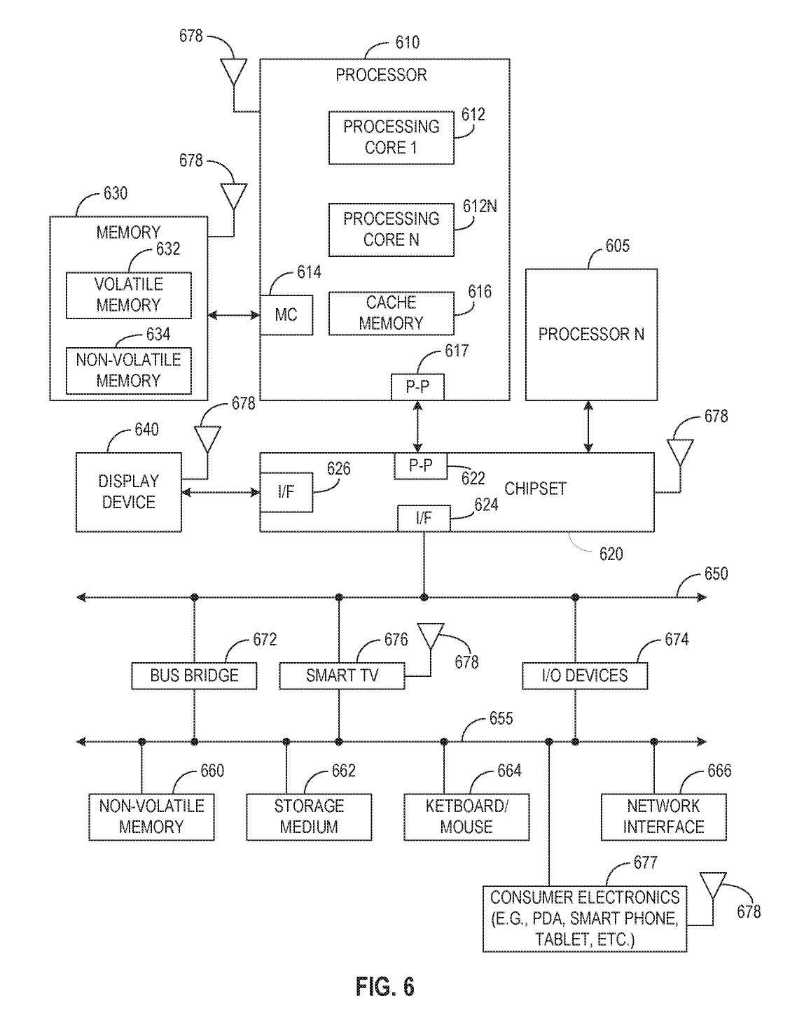

FIG. 6 illustrates a system level diagram, depicting an example of an electronic device (e.g., system) including a PCIe card as described in the present disclosure. FIG. 6 is included to show an example of a higher level device application for multiple device PCIe cards as discussed above. In one embodiment, system 600 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 600 is a system on a chip (SOC) system.

In one embodiment, processor 610 has one or more processor cores 612 and 612N, where 612N represents the Nth processor core inside processor 610 where N is a positive integer. In one embodiment, system 600 includes multiple processors including 610 and 605, where processor 605 has logic similar or identical to the logic of processor 610. In some embodiments, processing core 612 includes, but is not limited to, pre-fetch logic to fetch instructions, decode logic to decode the instructions, execution logic to execute instructions and the like. In some embodiments, processor 610 has a cache memory 616 to cache instructions and/or data for system 600. Cache memory 616 may be organized into a hierarchal structure including one or more levels of cache memory.

In some embodiments, processor 610 includes a memory controller 614, which is operable to perform functions that enable the processor 610 to access and communicate with memory 630 that includes a volatile memory 632 and/or a non-volatile memory 634. In some embodiments, processor 610 is coupled with memory 630 and chipset 620. Processor 610 may also be coupled to a wireless antenna 678 to communicate with any device configured to transmit and/or receive wireless signals. In one embodiment, an interface for wireless antenna 678 operates in accordance with, but is not limited to, the IEEE 802.11 standard and its related family, Home Plug AV (HPAV), Ultra Wide Band (UWB), Bluetooth, WiMax, or any form of wireless communication protocol.

In some embodiments, volatile memory 632 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 634 includes, but is not limited to, flash memory, phase change memory (PCM), read-only memory (ROM), electrically erasable programmable read-only memory (EEPROM), or any other type of non-volatile memory device.

Memory 630 stores information and instructions to be executed by processor 610. In one embodiment, memory 630 may also store temporary variables or other intermediate information while processor 610 is executing instructions. In the illustrated embodiment, chipset 620 connects with processor 610 via Point-to-Point (PtP or P-P) interfaces 617 and 622. Chipset 620 enables processor 610 to connect to other elements in system 600. In some embodiments of the example system, interfaces 617 and 622 operate in accordance with a PtP communication protocol such as the Intel® QuickPath Interconnect (QPI) or the like. In other embodiments, a different interconnect may be used.

In some embodiments, chipset 620 is operable to communicate with processor 610, 605N, display device 640, and other devices, including a bus bridge 672, a smart TV 676, I/O devices 674, nonvolatile memory 660, a storage medium (such as one or more mass storage devices) 662, a keyboard/mouse 664, a network interface 666, and various forms of consumer electronics 677 (such as a PDA, smart phone, tablet etc.), etc. In one embodiment, chipset 620 couples with these devices through an interface 624. Chipset 620 may also be coupled to a wireless antenna 678 to communicate with any device configured to transmit and/or receive wireless signals.

Chipset 620 connects to display device 640 via interface 626. Display 640 may be, for example, a liquid crystal display (LCD), a plasma display, cathode ray tube (CRT) display, or any other form of visual display device. In some embodiments of the example system, processor 610 and chipset 620 are merged into a single SOC. In addition, chipset 620 connects to one or more buses 650 and 655 that interconnect various system elements, such as I/O devices 674, nonvolatile memory 660, storage medium 662, a keyboard/mouse 664, and network interface 666. Buses 650 and 655 may be interconnected together via a bus bridge 672.

In one embodiment, mass storage device 662 includes, but is not limited to, a solid state drive, a hard disk drive, a universal serial bus flash memory drive, or any other form of computer data storage medium. In one embodiment, network interface 666 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 6 are depicted as separate blocks within the system 600, the functions performed by some of these blocks may be integrated within a single semiconductor circuit or may be implemented using two or more separate integrated circuits. For example, although cache memory 616 is depicted as a separate block within processor 610, cache memory 616 (or selected aspects of 616) can be incorporated into processor core 612.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

What is claimed is:

1. A Peripheral Component Interface Express (PCIe) card comprising:
a circuit board;
a first device mounted to the circuit board;
a second device mounted to the circuit board;
wherein the circuit board includes a single slot connector configured to mount and electrically connect the circuit board to a host motherboard of a host system;
wherein the first device is connected to a first plurality of data lane terminals of the single slot connector;
wherein the second device is connected to a second plurality of data lane terminals of the single slot connector; and
wherein the first plurality of data lane terminals is distinct from the second plurality of data lane terminals.

2. The PCIe card of claim 1, wherein the PCIe card does not include a switch to multiplex the first device and the second device with the data lane terminals of the single slot connector.

3. The PCIe card of claim 1, wherein the single slot connector is a Peripheral Component Interconnect Express (PCIe) connector.

4. The PCIe card of claim 1, wherein the single slot connector includes a number of PCIe transmit and receive terminal pairs and the number of PCIe transmit and receive terminal pairs is an even number greater than zero.

5. The PCIe card of claim 1, wherein a physical domain and an electrical domain of data lane signals of the first device are separate from a physical domain and an electrical domain of the second device.

6. The PCIe card of claim 1, wherein the single slot connector is configured to receive a clock signal and to distribute the clock signal to the first device and the second device.

7. The PCIe card of claim 1, wherein the single slot connector is configured to receive a control signal and to distribute the control signal to the first device and the second device.

8. The PCIe card of claim 1, wherein the first device is directly connected to a first N/2 data lanes of the single slot connector;
wherein the second device is directly connected to a second N/2 data lanes of the single slot connector;
wherein N is a positive even integer equal to or greater than 2; and
wherein the first N/2 data lanes is separate from the second N/2 data lanes.

9. The PCIe card of claim 1, wherein the single slot connector is configured to receive supporting signals of the first device and the second device;
wherein the PCIe card includes one or more buffers, mounted to the circuit board, to multiplex or distribute the supporting signals between the first device and the single slot connector, and between the second device and the single slot connector; and
wherein the supporting signals are not conducted using the data lane terminals.

10. The PCIe card of claim 1, including a system management bus device configured to couple to a system management bus of the host motherboard via the single slot connector.

11. The PCIe card of claim 10, wherein the system management bus device is configured to allow the host system to recognize the first plurality of data lane terminals of the single slot connector as a first, individual PCIe device, and to recognize the second plurality of data lane terminals of the single slot connector as a second, individual PCIe device.

12. The PCIe card of claim 11, wherein the system management bus device is configured to modify a basic input and output system (BIOS) of the host system upon power up of the PCIe card.

13. The PCIe card of claim 1, wherein the first device is a high speed Ethernet interface device.

14. The PCIe card of claim 1, wherein the second device is a high speed Ethernet interface device.

15. A method comprising:
communicating information via a plurality of devices mounted to an interface card having a single PCIe slot;
exchanging the information with a host system;
wherein the exchanging the information includes:
exchanging a first portion of the information using a first plurality of data lane terminals of the single PCIe slot;
exchanging a second portion of the information using a second plurality of data lane terminals of the single PCIe slot; and
wherein the method does not include operating a switch configured to connect one or more of the data lanes terminals with the plurality of devices.

16. The method of claim 15, including sharing one or more support signals exchanged with the host system with the plurality of devices; and
wherein the one or more support signals are not conducted using the first plurality of data lane terminals or the second plurality of data lane terminals.

17. The method of claim 16, wherein the first plurality of data lane terminals of the single PCIe slot are separate from second plurality of data lane terminals of the single PCIe slot.

18. A network interface card comprising:
a circuit board;
a first network interface controller mounted to the circuit board;
a second network interface controller mounted to the circuit board;
wherein the circuit board includes a single slot connector for mounting and electrically connecting the circuit board to a host motherboard;
wherein the first network interface controller is assigned a first plurality of terminals of the single slot connector;
wherein the second network interface controller is assigned a second plurality of terminals of the single slot connector; and
wherein the first plurality of terminals is distinct from the second plurality of terminals.

19. The network interface card of claim 18, wherein the network interface card does not include a network switch to multiplex the first network interface controller and the second network interface controller with the single slot connector.

20. The network interface card of claim 18, wherein the single slot connector is a Peripheral Component Interconnect Express (PCIe) connector.
